(19) United States
(12) Patent Application Publication
(10) Pub. No.: US 2003/0187963 A1
(43) Pub. Date: Oct. 2, 2003

(54) Method for automatically setting network configuration of portable communication device

(75) Inventors: Shih-Kuang Tsai, Taipei Hsieng (TW); Pei-Chih Li, Shanghai City (CN); Wen-Chiang Chin, Shanghai City (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsieng (TW)

(21) Appl. No.: 10/108,343

(22) Filed: Mar. 29, 2002

(51) Int. Cl. G06F 15/177

(52) U.S. Cl. 709/220

(57) ABSTRACT

A method for carrying out an automatic setting of network configuration of a portable communication device capable of accessing the Internet by wireless and having a network configuration database containing identifications (IDs) of Internet service providers (ISPs) and online basic data corresponding to the IDs, the method comprising the steps of reading the ID of the ISP in a subscriber identity module (SIM) card in the communication device; reading the online basic data from the network configuration database based on the ID; and setting a network configuration of the communication device. By utilizing this method, network configuration of the communication device can be set automatically by reading SIM card.

### BACKGROUND OF THE INVENTION

1. Field of the Invention

The present invention relates to portable communication devices and more particularly to a method for automatically setting network configuration of such a portable communication device.

2. Description of Related Art

Recently, communication technologies have known a rapid and a spectacular development leading to an increasing use of communication devices in addition to their competitively low prices. The popularity of cellular phones is an example. Moreover, there is a trend of developing slim, compact communication devices due to the development of electronics. Further, the functions of a communication device may incorporate features of many consumer electronic products to form a multifunctional one. For example, a communication device having hardware and software complying with wireless application protocol (WAP) is capable of accessing to the Internet by wireless so as to retrieve information from millions of sources. Furthermore, a mobile e-commerce is made possible over the Internet.

Conventionally, online data contained in network configuration provided by an Internet service provider (ISP) comprises unique setting parameters. Further, user has to perform a setting of a known communication device based on the above online data prior to using a Web browsing software. As to the setting, user has to repeatedly press keys of communication device by following instructions shown on display of the communication device. It is quite inconvenient for user. This is particularly true for a beginner who is totally unfamiliar with operation of the communication device.

For example, a user wants to use an online feature of his/her cellular phone for browsing world wide web (the Web). Thus, the user is required to perform a setting on each one of a plurality of items of network configuration. Items of the network configuration comprise home page position, dialing procedure, linking address of server, telephone number, linking type, etc. As to the settings of dialing procedure and linking type, they are typically done through a simple, short procedure. As to home page position, linking address of server, and telephone number, each consists of several characters (e.g., digit or alphabet). As to alphanumeric keypad of a cellular phone, several different keys (e.g., keys A, B, and C) are integral on the same numeric key (e.g., key numbered 1) due to limited size of cellular phone. This means that user has to press keys several times for inputting a character. Thus, time and complexity in completing a setting of home page position, linking address of server, or telephone number is very significant. And in turn it increases chances of committing errors during input. Moreover, any wrong key pressing will fail the setting and thus prohibiting the Web browsing. In view of above, the prior art is not user friendly. Thus improvement exists.

### SUMMARY OF THE INVENTION

It is therefore an object of the present invention to provide a method for carrying out an automatic setting of network configuration of a portable communication device capable of accessing the Internet by wireless, the communication device having a network configuration database containing identifications (IDs) of Internet service providers (ISPs) and online basic data corresponding to the IDs, the method comprising the steps of reading the ID of the ISP in a subscriber identity module (SIM) card in the communication device; reading the online basic data from the network configuration database based on the ID; and setting a network configuration of the communication device. By utilizing this method, network configuration of the communication device can be set automatically by reading SIM card. User is thus permitted to access to the Internet. This eliminates the procedure of repeatedly pressing keys for setting the network configuration as experienced in the prior art. Thus, the benefits such as user friendly, competitive in market, and fast access to the Internet are obtained by the communication device.

The above and other objects, features and advantages of the present invention will become apparent from the following detailed description taken with the accompanying drawings.

### BRIEF DESCRIPTION OF THE DRAWINGS

FIG. 1 is a flow chart illustrating a method for automatically setting network configuration of portable communication device according to the invention.

### DETAILED DESCRIPTION OF THE PREFERRED EMBODIMENTS

The invention is directed to a method for carrying out an automatic setting of network configuration of a portable communication device capable of accessing the Internet by wireless, the communication device having a network configuration database containing identifications (IDs) of Internet service providers (ISPs) and online basic data corresponding to the IDs. The method comprises the steps of reading the ID of the ISP in a subscriber identity module (SIM) card in the communication device; reading the online basic data from the network configuration database based on the ID; and setting a network configuration of the communication device. By utilizing this method, network configuration of the communication device can be set automatically by reading SIM card. User is thus permitted to access to the Internet. This eliminates the procedure of repeatedly pressing keys for setting the network configuration as experienced in the prior art.

In the invention the online basic data comprises parameters of the network configuration provided by the ISP comprising a telephone number, a dialing procedure, a linking address of server, a linking type, a home page position, a user name, and a password so that the online basic data is operative to automatically set the parameters to corresponding positions by the communication device.

In the invention the network configuration and the parameters of the network configuration contained in the online basic data are operative to update. The updating means creation, deletion, or modifying. Such is well known. Thus a detailed description thereof is omitted herein for the sake of brevity.

In the invention the network configuration and the parameters of the network configuration contained in the online basic data is done by receiving the updated data containing the network configuration and the parameters of the network configuration through electronic messages (e.g., e-mail), and automatically setting the updated data to the corresponding positions of the parameters of the network configuration by the communication device for further updating. Data updating by e-mail is well known in the art of data communication. Accordingly, a detailed description thereof is omitted herein for purposes of brevity and convenience only, and is not limiting.

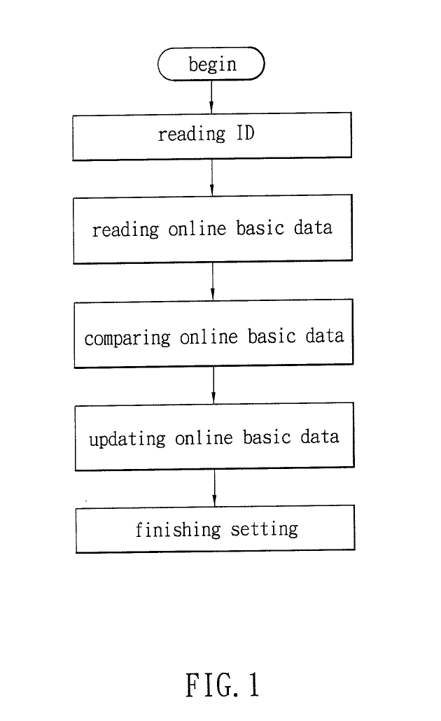

Referring to FIG. 1, there is shown a process performed by a control circuit of a portable communication device for automatically setting network configuration thereof in accordance with the invention. The process comprises the following steps:

First read an ID of ISP in SIM card in the communication device.

Then read an online basic data from a network configuration database based on the ID.

Next, compare the online basic data of the network configuration database with original online basic data of the communication device.

Thereafter, update any inconsistent parameters for conforming to the online basic data of the network configuration database.

A setting of network configuration is complete after the updating.

In brief, after network configuration of the communication device has been set automatically, user is permitted to access to the Internet. This eliminates the procedure of repeatedly pressing keys for setting a network configuration as experienced in the prior art. Thus, the benefits such as user friendly, competitive in market, and fast access to the Internet are obtained by the communication device of the invention.

While the invention herein disclosed has been described by means of specific embodiments, numerous modifications and variations could be made thereto by those skilled in the art without departing from the scope and spirit of the invention set forth in the claims.

What is claimed is:

1. A method for carrying out an automatic setting of network configuration of a portable communication device capable of accessing the Internet by wireless, the communication device having a network configuration database containing identifications (IDs) of Internet service providers (ISPs) and online basic data corresponding to the IDs, the method comprising the steps of:
reading the ID of the ISP in a subscriber identity module (SIM) card in the communication device;
reading the online basic data from the network configuration database based on the ID; and
setting a network configuration of the communication device.

2. The method of claim 1, wherein the online basic data comprises parameters of the network configuration provided by the ISP comprising a telephone number, a dialing procedure, a linking address of server, a linking type, a home page position, a user name, and a password so that the online basic data is operative to automatically set the parameters to corresponding positions by the communication device.

3. The method of claim 2, wherein the network configuration and the parameters of the network configuration contained in the online basic data are operative to update.

4. The method of claim 2, wherein the updating of the network configuration and the parameters of the network configuration contained in the online basic data is done by receiving the updated data containing the network configuration and the parameters of the network configuration through electronic messages, and automatically setting the updated data to the corresponding positions of the parameters of the network configuration by the communication device for further updating.

5. The method of claim 1, wherein in setting the network configuration a control circuit of the communication device performs the steps of:
reading the ID of the ISP in the SIM card in the communication device;
reading the online basic data from the network configuration database based on the ID;
comparing the online basic data of the network configuration database with original online basic data of the communication device;
updating any inconsistent parameters for conforming to the online basic data of the network configuration database; and
setting the network configuration of the communication device.
